(19) United States
(12) Patent Application Publication
(10) Pub. No.: US 2011/0107081 A1
(43) Pub. Date: May 5, 2011

(54) METHOD AND APPARATUS FOR PROCESSING OF BROADCAST DATA

(76) Inventors: Keum-Yong Oh, Gyeonggi-do (KR); Jun-Ho Jang, Gyeonggi-do (KR); Gyung-Pyo Hong, Gyeonggi-do (KR); Young-Min Park, Gyeonggi-do (KR); Hae-Su Gwon, Gyeonggi-do (KR)

(21) Appl. No.: 12/934,437

(22) PCT Filed: Mar. 24, 2008
(86) PCT No.: PCT/KR2008/001634

§ 371 Date: Dec. 13, 2010

(51) Int. Cl. H04L 9/00

(52) U.S. Cl. 713/150

(57) ABSTRACT

A plurality of conditional access (CA) clients are needed to receive services from a plurality of service, where the CA clients respectively correspond to the service providers. Thus, the CA clients should be installed into a broadcast receiver, and in this case, a method of managing the CA clients is needed. Provided are a method and apparatus for processing broadcast data by using a security client. The method includes determining a first security client based on a security client list, where the first security client is used to decrypt encrypted broadcast data and the security client list comprises information regarding each of security clients available which provide information necessary to decrypt the encrypted broadcast data; and decrypting the encrypted broadcast data by using the first security client. Accordingly, it is possible to allow a user to receive various services.

### TECHNICAL FIELD

The present invention relates to a method and apparatus for processing broadcast data, and more particularly, to a method and apparatus for processing broadcast data by using a security client.

### BACKGROUND ART

Today, digital broadcasting has been rapidly spread through the existing media that include not only terrestrial broadcasting or satellite broadcasting but also cable broadcasting. Accordingly, the environment of the industry of broadcasting has been innovatively changed.

A service provider who provides digital broadcast services can encrypt and transmit specific content so that only users who paid additional fees therefor can use the contents. In this case, the users who paid the additional fees can use the encrypted content by receiving a module for decrypting the encrypted content from the service provider, installing the module into a broadcast receiver, and obtaining information necessary to decrypt the encrypted content by using the module. A conditional access system (CAS) is a representative system for charging for charged content or placing restriction on use of the charge content according to age. In the CAS, broadcast content is used by installing a conditional access (CA) client provided from a service provider into a broadcast receiver and decrypting encrypted content by using the CA client. The CA client may be directly installed into the broadcast receiver or may be mounted into a smart card.

In general, a user pays a fee to one service provider and installs a CA client provided from the service provider into a broadcast receiver. The CA client can decrypt only contents provided from the service provider and cannot decrypt contents provided from the other service providers. Thus, if the user wants to cancel the contract between the user and the service provider and to receive a service from a new service provider, for example, when the user moves to another region, then the installed CA client should be replaced with a CA client provided from the new service provider.

If one service provider exists in each region and thus a user receives contents from only one service provider, then it is sufficient to install only one CA client into a broadcast receiver. However, if digital broadcasting technology will be developed more and more, a user may receive contents from a plurality of service providers by paying fees for the contents to the service providers. Also, one service provider may provide a plurality of charged products by changing the quality and quantity of content according to fee that a user pays.

In order for a user to receive services from a plurality of service providers, the user needs a plurality of CA clients corresponding to the respective service providers and, thus, the plurality of the CA clients should be installed into a broadcast receiver. In this case, there is a need for a method of managing the plurality of the CA clients.

### BRIEF DESCRIPTION OF THE DRAWINGS

FIG. 1 is a block diagram of a cable broadcast providing system according to an embodiment of the present invention.

FIG. 2 is a block diagram of a security client list employed in a broadcast processing apparatus that includes a plurality of security clients a according to an embodiment of the present invention.

FIG. 3 is a block diagram of a broadcast data processing system using a plurality of security clients according to an embodiment of the present invention.

FIG. 4 is a block diagram of a broadcast data processing system using a plurality of security clients according to another embodiment of the present invention.

FIG. 5 is a block diagram of a broadcast data processing apparatus according to an embodiment of the present invention.

FIG. 6 is a flowchart illustrating a broadcast data processing method according to an embodiment of the present invention.

### DETAILED DESCRIPTION OF THE INVENTION

### Technical Problem

A method of managing a plurality of conditional access (CA) clients is needed.

### Technical Solution

The present invention provides a method and apparatus for efficiently processing broadcast data by using a plurality of security clients installed.

### Advantageous Effects

It is possible to receive various services by installing security clients corresponding to a plurality of respective service providers.

Even if a user is subscribed to only one service provider, the user may receive various services by installing security clients corresponding to the various services based on the policies of the service provider.

It is possible to effectively manage a plurality of security clients by using a security client list.

### Best Mode

According to an aspect of the present invention, there is provided a method of processing broadcast data, the method including determining a first security client based on a security client list, where the first security client is used to decrypt encrypted broadcast data and the security client list includes information regarding each of security clients available which provide information necessary to decrypt the encrypted broadcast data; and decrypting the encrypted broadcast data by using the first security client.

The security clients may be software-based modules installed into at least one hardware-based security module which operates the security clients.

The security client list may include at least one of information regarding communication devices being respectively employed by the security clients in order to communicate with an external server which provides broadcast data; information regarding the security clients installed into the at least one security module; and version information of the respective security clients.

If the information regarding the security clients is changed, the method may further include upgrading the security client list.

The upgrading of the security client list may include adding information regarding a new security client into the security client list when a new security module having the new security client is accessed.

The method may further include receiving upgrade data necessary to upgrade the first security client; and upgrading the first security client to be a second security client based on the upgrade data. When the first security client is upgraded to be the second security client, the upgrading of the security client list may include upgrading information regarding the first security client, which is included in the security client list, with information regarding the second security client.

The at least one security module may include a universal serial bus (USB) or a smart card.

The security clients may be software-based modules that constitute a conditional access system (CAS).

According to another aspect of the present invention, there is provided an apparatus for processing broadcast data, the method including a determination unit determining a first security client based on a security client list, where the first security client is used to decrypt encrypted broadcast data and the security client list includes information regarding each of security clients available which provide information necessary to decrypt the encrypted broadcast data; and a decryption unit decrypting the encrypted broadcast data by using the first security client.

### Mode of the Invention

Hereinafter, exemplary embodiments of the present invention will be described in detail with reference to the accompanying drawings.

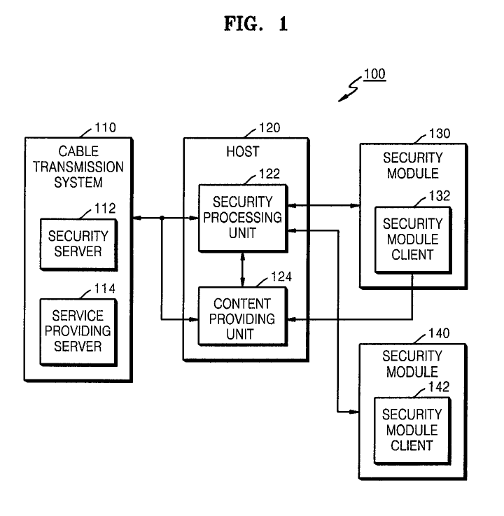

FIG. 1 is a block diagram of a cable broadcast providing system 100 according to an embodiment of the present invention. A cable transmission system 110 is a head end that transmits a digital cable broadcast, and includes a security server 112 that processes security policies of a host 120 and a service providing server 114 that provides a multimedia service including a data broadcast content to the host 120.

The host 120 allows a user to watch a broadcast content provided from the cable transmission system 110, and includes a security processing unit 122 and a content providing unit 124. The security processing unit 122 relays communication between the security server 112 and a security module 130 which will later be described. The content providing unit 124 performs demultiplexing and decoding so that a user may watch content provided from the cable transmission system 110.

The security module 130 is hardware-based module that establishes communication with the security server 112 via the security processing unit 122. A software-based security client 132 distributed by the security server 112 is installed into the security module 130, and the security module 130 drives the security client 132. The security client 132 may be classified as a digital rights management (DRM) client, a conditional access system (CAS) client, or an ASD client according to function. Hereinafter, for convenience of explanation, it is assumed that the security client 132 is a CAS client. The security module 130 is a module, e.g., a universal serial bus (USB) or a smart card, which is separated from the host 120, and may communicate with the host 120 via a USB interface, a smart card interface and a network interface that are installed into the host 120. Otherwise, the security module 130 may be embodied in the form of a chip set inside the host 120 in order to establish message communication or data communication with the constitutional elements of the host 120.

The CAS client 132 is software distributed by the security server 112 and realizes a CAS in the host 120. The CAS client 132 is delivered from the security server 112 to the host 120 using a communication method, such as a DSG (DOCSIS Set-top Gateway) or an in-band, and is installed into the security module 130 via communication between the host 120 and the security module 130. In general, the CAS client 132 is classified according to a service provider but may depend on the type of a service provided even if it is distributed from the same service provider.

The CAS client 132 is capable of decrypting content received from only a corresponding service provider.

A method of providing broadcast content from the cable broadcast providing system 100 will now be described with reference to FIG. 1.

The host 120 recognizes a security module that is internally or externally connected thereto in an initial booting stage, and performs authentication together with the security module 130. After authentication between the host 120 and the security module 130 is completed, the host 120 and the security module 130 may communicate with each other.

The cable transmission system 110 encrypts charged content and delivers it to the host 120. In this case, security policy information corresponding to the host 120 is delivered together with the encrypted content. In the present specification, security policy information is used to apply security policies to the host 120 according to contract between a service provider and a user, and may include information necessary to perform authentication between the cable transmission system 110 and the host 120, information necessary to generate a decryption key for decrypting content, information for controlling redistribution of content.

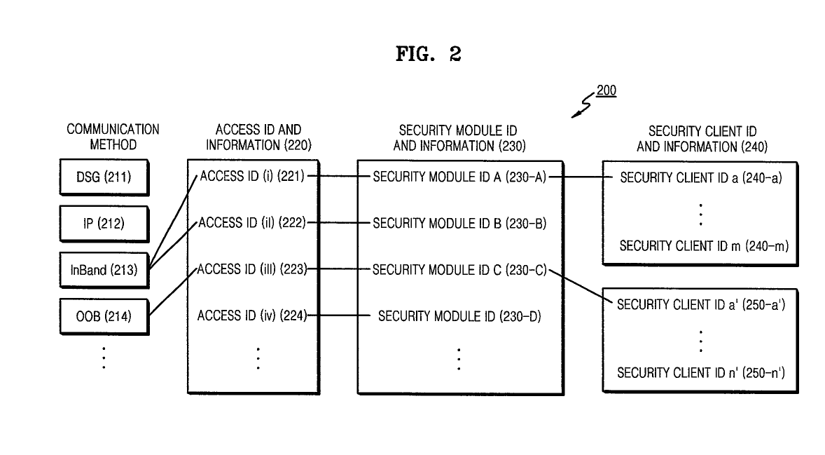

In some cases, the host 120 may be connected to a plurality of security modules 130 and 140 each having a security client or to one security module having two or more security clients. In this case, the host 120 determines a security client that is to be used to decrypt the encrypted content. Hereinafter, a client that is to be used to decrypt content is referred to as a first security client. The host 120 determines the first security client by using a security client list that will be described later. The security client list and a method of determining the first security client based on security client list will be described in detail with reference to FIG. 2 later.

For convenience of explanation, it is assumed that a first security client is the CAS client 132.

The host 120 receives the security policy information and delivers it to the CAS client 132.

The CAS client 132 performs authentication between the host 120 and the cable transmission system 110 by using the security policy information. For example, the authentication may be performed by comparing the identification (ID) number of the host 120 with an ID number contained in security policy information. When the authentication between the host 120 and the cable transmission system 110 fails, the operation of the CAS client 132 is discontinued so that a user cannot receive a broadcast service any longer. However, even if the CAS client 132 continuously operates, the decryption key cannot be successfully generated, and thus, the user cannot watch the charged content.

When the authentication between the host 120 and the cable transmission system 110 is completed, the CAS client 132 generates information, e.g., the decryption key, which is necessary to decrypt the encrypted content based on the security policy information. If the host 120 has no right to watch the charged content, the CAS client 132 cannot generate the decryption key.

The host 120 receives the decryption key from the CAS client 132 and decrypts the encrypted content. The content providing unit 124 sequentially performs demultiplexing, decoding and rendering on the decrypted content so that the user can watch the content.

FIG. 2 is a block diagram of a security client list 200 employed in a broadcast processing apparatus that includes a plurality of security clients a according to an embodiment of the present invention.

The security client list 200 includes information regarding each of security clients that can be used. For example, the security client list 200 includes information regarding a communication method that is employed by each of security clients in order to communicate with an external server that provides broadcast data, information regarding a security module into each of the security clients is installed, and version information of each of security modules and the security clients. However, the above information is just an example of information that may be included in the security client list 200. The security client list 200 may include various information regarding the security clients, e.g., information regarding the manufacturers and manufacturing dates of the security modules and the security clients.

Security client ID and information 240 includes ID and version information of each of the security clients.

Security module ID and information 230 includes ID and version information of each of the security modules.

Access ID and information 220 includes ID of and information regarding a communication method that each of the security clients uses to communicate with a security server. Each of the security clients communicates with the security server via a host, and thus, a communication method used to communicate between the security client and the security server is determined according to a communication network used between the security server and the host.

For example, a DSG 211, an internet protocol (IP) 212, an in-band 213 or an OOB (out of band) 214 may be used as a communication method in order to communicate between the security server and the host via a cable network may be. The DSG 211 is a communication method for communicating with the host by using a DOCSIS, and the IP 212 is a communication method for communicating with the host via IP communication. The in-band 213 is a data transmission bandwidth allocated to each of service providers. In general, a service provider provides broadcast data by using the in-band 213. The OOB 214 is a region outside the in-band 213 and generally means a low-frequency bandwidth. The OOB 214 is difficult to transmit a big amount of data but may be used to transmit a small amount of data for communication between the security server and each of the security clients. The above communication methods used for communication between the security server and the security clients are just examples and other communication methods, such as a wireless communication network, may be used.

Information regarding a security client installed into each of the security modules may be expressed using mapping information between security module ID and security client ID. Referring to FIG. 2, m security clients 240-a through 240-m are installed into in a security module A 230-A, and n security clients 250-a′ through 250-n′ are installed into a security module B 230-B.

Also, information regarding a communication method that each of the security clients uses for communication with the security server may be expressed using mapping information between the security client ID and access ID. Referring to FIG. 2, access ID(i) 221 and access ID(ii) 222 correspond to the in-band 213. Thus, the security clients 240-a through 240-m installed into the security module A 230-A communicate with the security server 112 via the in-band 213. Also, access ID(iii) 223 corresponds to the OOB 214. Thus, the security clients 250-a′ through 250-n′ installed into the security module C 230-C communicate with the security server 112 via the OOB 214. In FIG. 2, it is assumed that security clients installed into the same security module use the same communication method but the security clients installed into the same security module use may use different communication methods.

The host 120 of FIG. 1 determines a first security client that is to be used for decrypting encrypted broadcast data, based on the security client list 200. The host 120 may determine the first security client in various ways.

For example, it is assumed that the security server 112 transmits security policy information to the host 120 by using a communication method from among the DSG 211, the IP 212, the in-band 213 and the OOB 214. The host 120 detects security clients that communicate with the security server 112 by using the communication method used to transmit the security policy information based on the security client list 200, and transmits the security policy information to the detected security clients. Only a security client that is distributed from the security server 112 can perform authentication with the host 120 and generate a decryption key from among the security clients that receive the security policy information. Thus, the host 120 determines as a first client the security client that delivers either a message indicating that the authentication is successfully performed or the decryption key.

It is assumed that the security server 112 transmits the security policy information to the host 120 via the in-band 213. The host 120 transmits the received security policy information to the security module A 230-A and the security module B 230-B. If the security client m 240-m is distributed from the security server 112, only the security client m 240-m will deliver the decryption key to the host 120. Thus, the security client m 240-m is determined to be the first security client.

As another example, when the security server 112 transmits information, such as the manufacturing date and manufacturer of the first security client, to the host 120, the host 120 directly searches the security client list 200 for the first security client corresponding to the received information.

If the first security client is searched for, the host 120 relays communication between the first security client and the security server 112.

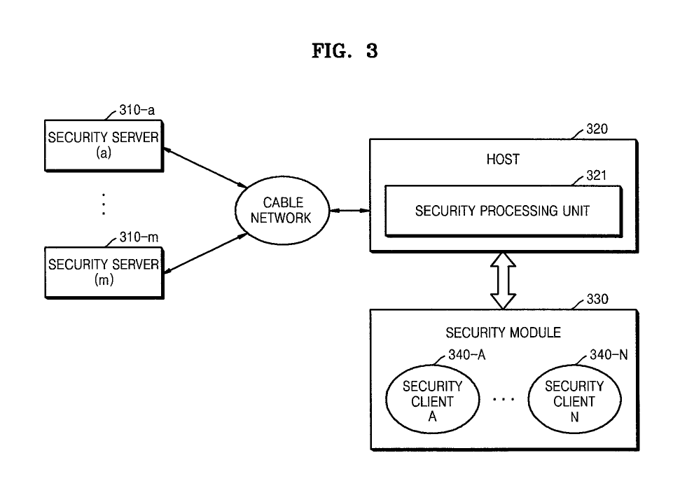

FIG. 3 is a block diagram of a broadcast data processing system using a plurality of security clients according to an embodiment of the present invention. Referring to FIG. 3, one security module 330 is located outside a host 320, and N security clients 340-A through 340-N are installed into the security module 330. In order to communicate with the host 320, the security module 330 selects and uses a device, such as an USB interface, a smart card interface, or an IEEE 1394 network, according to the shape of the security module 330, via which data or a message is delivered.

In general, the host 320 is connected to the plurality of the security clients 340-A through 340-N as illustrated in FIG. 3 when a user desires to receive broadcast services from a plurality of service providers. This is because broadcast data provided from each of the service providers can be respectively decrypted only using a security client distributed from the corresponding service provider.

A method of processing broadcast data received from an external server will now be described.

First, when the host 320 is powered on, the host 320 searches the security module 330 connected thereto. In this case, each of the security clients 340-A to 340-N installed in the security module 330 informs the host 320 of a communication method that is to be used for communicating with security servers 310-a through 310-m. The host 320 generates the security client list 200 of FIG. 2 using communication methods informed by the security client. If the security servers 310-a to 310-m are connected to the host 320 via a cable network, a DSG/DOCSIS, an IP, an OOB, or an in-band will be employed as a communication method. After such initial setting is completed, communication may be established between a security server that provides broadcast data and a first security client.

For convenience of explanation, it is assumed that the security server a 310-a distributes the security client A 340-A and the security server b 310-b distributes the security client B 340-B. Also, it is assumed that a service provider who is currently providing a broadcast service manages the security server a 310-a. Thus, the first security client is determined to be the security client A 340-A.

If the security server 310-a transmits a message and encrypted data to the host 320 using a communication method used for communication between the security server 310-a and the first security client 340-A, the host 320 relays and delivers the message and the encrypted data to the security module 330. In this case, the security module 330 compares the version information of the first security client 340-A with security client information received from the security server 310-a, and determines whether upgrading is needed.

If the first security client 340-A needs to be upgraded, the security module 330 transmits a signal requesting upgrading to the host 320 and the host 320 delivers this signal to the security server 310-a. Upon receiving this signal, the security server 310-a delivers information necessary to upgrade the first security client 340-A to the host 320. When the host 320 delivers the information necessary to upgrade the first security client 340-A to the security module 330, the security module 330 upgrades the first security client 340-A to be a second security client based on this information.

After the upgrading is completed, the host 320 upgrades information regarding the first security client 340-A, which is included in the security client list 200, with information regarding the second security client. The security client list 200 includes access ID and information, security module ID and information, security client ID and information, and mapping information therebetween as described above.

Thereafter, the host 320 decrypts the encrypted data by using the first security client 340-A and provides the result of decrypting to the user. A security client may be selected from among various security clients, such as a digital rights management (DRM) client and a CAS client, according to a function required. Hereinafter, a method of processing broadcast data will be described on an assumption that a security client is a CAS client.

In a CAS, the security server 310-a transmits an entitlement management message (EMM) and an entitlement control message (ECM) together with encrypted broadcast data to the host 320, and the host 320 delivers them to the first security client. The first security client determines whether the host 320 has a right to receive the encrypted broadcast data according to the EMM. That is, the first security client performs authentication between the host 320 and the security server 310-a. For example, the ID number of the host 320 is compared with that of a broadcast receiver, which is transmitted via the EMM, and it is determined that the authentication between the host 320 and the security server 310-a is successfully performed when the two ID numbers are the same.

If the authentication is successfully performed, the first security client generates a decryption key for decrypting the encrypted broadcast data by using an authentication key obtained from the EMM and the ECM. When the decryption key is delivered to the host 320, the host 320 decrypts the encrypted broadcast data by using the decryption key, and provides a service by performing a decoding process.

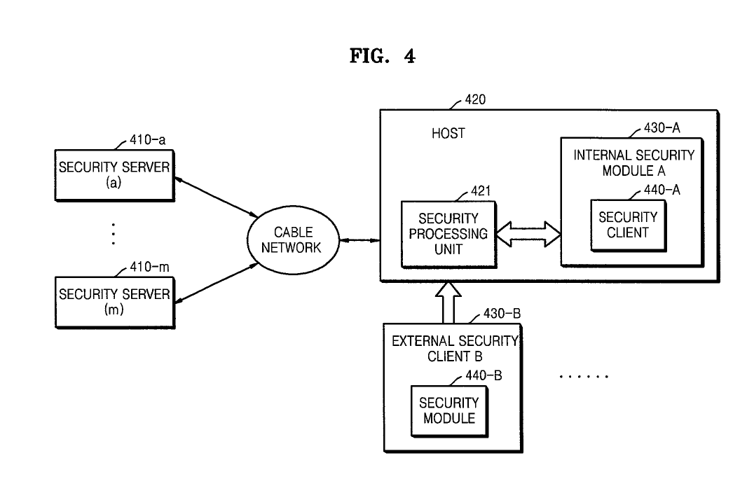

FIG. 4 is a block diagram of a broadcast data processing system using a plurality of security clients according to another embodiment of the present invention. Referring to FIG. 4, one internal security module 230-A exists inside a host 420, and a plurality of security modules 430-B to 430-N exist outside the host 420. Also, one security client is installed in each of these security modules.

The operations of the broadcast data processing system of FIG. 4 are similar to those of the broadcast data processing system of FIG. 3, and thus will be described focusing on the differences between broadcast data processing systems of FIGS. 3 and 4.

It is assumed that a new security module is connected to the host 420 during operation of the broadcast data processing system of FIG. 4 and one new security client is installed into the new security module. The new security module may be inserted into the host 420 in the form of a USB or may be connected to the host 420 via a network. When the new security module is connected to the host 420, a security processing unit 421 recognizes the connection, and adds information regarding the new security client to the above security client list 200 while identifying a communication method that is to be used for the new security module to communicate with a security server. If the new security client is distributed from the security server, it is determined whether to upgrade the new security client by communicating with the security server.

If the new security module has no security client, a security client may be downloaded from an external server.

Similarly, even if a security module is detached or disconnected from the host 420, the host 420 upgrades the security client list 200. In this case, information regarding a security client installed into the detached or disconnected security module is deleted from the security client list 200.

FIG. 5 is a block diagram of a broadcast data processing apparatus 500 according to an embodiment of the present invention. The broadcast data processing apparatus 500 includes a determination unit 510 and a decryption unit 520.

The determination unit 510 determines a first security client that is to be used for decrypting encrypted broadcast data, based on a security client list that includes information regarding each of security clients that can be used and provides information necessary to decrypt the encrypted broadcast data. The first security client may be selected from among a CAS client, a DRM client and an ASD client according to a manner in which the broadcast data has been encrypted. Here, the security clients are software-based modules. Each of the security clients is installed into a hardware-based security module that operates security clients.

The security module may be a USB or a smart card which is separated from the broadcast data processing apparatus 500. In this case, the broadcast data processing apparatus 500 should include a communication interface for communicating with the security module. The communication interface may be selected from among various interfaces, such as an USB interface (I/F), a smart card I/F and a wired/wireless interface, according to the shape of the security module. However, the security module may not be separated from the broadcast data processing apparatus 500, and may instead be embodied in the form of a chip set in the broadcast data processing apparatus 500 in order to establish message/data communication with the constitutional elements included in the broadcast data processing apparatus 500.

In order to communicate with an external server that provides data, the security client list may include at least one of information regarding communication methods employed by the respective security clients, information regarding a security client installed into at least one security module, and version information of the security clients. As described above, the information regarding the communication method is expressed using mapping information between security client ID and access ID, and the information regarding the installed security client may be expressed using mapping information between security client ID and security module ID.

The broadcast data processing apparatus 500 may further include a receiving unit (not shown) in order to receive encrypted broadcast data from an external server. The receiving unit may receive security policy information, the encrypted broadcast data and upgrade data necessary to update a security client. The security policy information allows security policies, which are determined between the broadcast data processing apparatus 500 and broadcast server, to be applied to the broadcast data processing apparatus 500. The security policy information includes information necessary to perform authentication between the broadcast data processing apparatus 500 and the broadcast server and information for generating a decryption key.

If the receiving unit receives the upgrade data, the broadcast data processing apparatus 500 upgrades the first security client. To this end, the broadcast data processing apparatus 500 may further include an upgrade controller (not shown). The upgrade controller controls the first security client to be upgraded to be a second security client, based on the upgrade data. In detail, when the upgrade data is delivered to the security module having the first security client, the security module upgrades the first security client.

The receiving unit may further receive information for identifying the first security client from an external server. The determination unit 510 determines from the security client list a security client, which corresponds to the information for identifying the first security client the security client list, to be the first security client. In this case, the security policy information may be delivered only to the first security client.

However, if the information for identifying the first security client is not received from an external server, the determination unit 510 transmits the security policy information to more than one security client. The security client list includes information regarding the communication methods. Thus, the security policy information is delivered to security clients that employ the communication method that was used to transmit the security policy information. When the first security client receives the security policy information, the first security client may generate a decryption key or may transmit a message confirming that the first security client itself is the first security client.

The broadcast data processing apparatus 500 may further include a list management unit that the upgrades the security client list when information regarding the security clients is changed. The list management unit adds information regarding a new security client to the security client list when a new security module having the new security client is connected to the list management unit. Similarly, when a security module is disconnected from the list management unit, information regarding a security client installed into the security module is deleted from the security client list.

If the first security client is upgraded to be the second security client, the list management unit upgrades the information regarding the first security client that is included in the security client list with the information regarding the second security client.

The decryption unit 520 decrypts the encrypted broadcast data by using the first security client. The decryption unit 520 obtains information necessary to decrypt the encrypted broadcast data from the first security client, and decrypts the broadcast data by using the obtained information. The information necessary to decrypt the broadcast data may be a decryption key corresponding to the encrypted broadcast data.

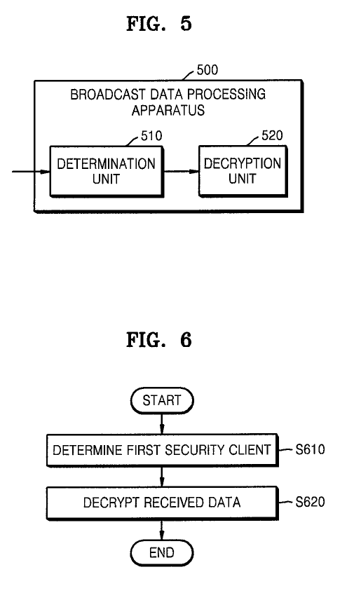

FIG. 6 is a flowchart illustrating a broadcast data processing method according to an embodiment of the present invention. In operation S610, a first security client that is to be used to decrypt received broadcast data, is determined using a security client list that includes information reading each of security clients that can be used and provide information necessary to decrypt the broadcast data.

In operation S620, the broadcast data is decrypted using the first security client.

The above embodiments of the present invention may be embodied as a computer program. The computer program may be stored in a computer readable recording medium, and executed using a general digital computer.

Examples of the computer readable medium include a magnetic recording medium (a ROM, a floppy disc, a hard disc, etc.), and an optical recording medium (a CD-ROM, a DVD, etc.).

While this invention has been particularly shown and described with reference to exemplary embodiments thereof, it will be understood by those of ordinary skill in the art that various changes in form and details may be made therein without departing from the spirit and scope of the invention as defined by the appended claims.

1. A method of processing broadcast data, the method comprising:
determining a first security client based on a security client list, where the first security client is used to decrypt encrypted broadcast data and the security client list comprises information regarding each of security clients available which provide information necessary to decrypt the encrypted broadcast data; and
decrypting the encrypted broadcast data by using the first security client.

2. The method of claim 1, wherein the security clients are software-based modules installed into at least one hardware-based security module which operates the security clients.

3. The method of claim 2, wherein the security client list comprises at least one of:
information regarding communication devices being respectively employed by the security clients in order to communicate with an external server which provides broadcast data;
information regarding the security clients installed into the at least one security module; and
version information of the respective security clients.

4. The method of claim 2, if the information regarding the security clients is changed, further comprising upgrading the security client list.

5. The method of claim 4, wherein the upgrading of the security client list comprises adding information regarding a new security client into the security client list when a new security module having the new security client is accessed.

6. The method of claim 4, further comprising:
receiving upgrade data necessary to upgrade the first security client; and
upgrading the first security client to be a second security client based on the upgrade data, and
wherein when the first security client is upgraded to be the second security client, the upgrading of the security client list comprises upgrading information regarding the first security client, which is included in the security client list, with information regarding the second security client.

7. The method of claim 2, wherein the at least one security module comprises a universal serial bus (USB) or a smart card.

8. The method of claim 1, wherein the security clients are software-based modules that constitute a conditional access system (CAS).

9. An apparatus for processing broadcast data, the method comprising:
a determination unit determining a first security client based on a security client list, where the first security client is used to decrypt encrypted broadcast data and the security client list comprises information regarding each of security clients available which provide information necessary to decrypt the encrypted broadcast data; and
a decryption unit decrypting the encrypted broadcast data by using the first security client.

10. The apparatus of claim 9, wherein the security clients are software-based modules installed into at least one hardware-based security module which operates the security clients.

11. The apparatus of claim 10, wherein the security client list comprises at least one of:
information regarding communication devices being respectively employed by the security clients in order to communicate with an external server which provides broadcast data;
information regarding the security clients installed into the at least one security module; and
version information of the respective security clients.

12. The apparatus of claim 10, further comprising a list management unit upgrading the security client list when the information regarding the security clients is changed.

13. The apparatus of claim 12, wherein the list management unit adds information regarding a new security client into the security client list when a new security module having the new security client is connected to the list management unit.

14. The apparatus of claim 12, further comprising:
a receiving unit receiving upgrade data necessary to upgrade the first security client; and
an upgrade unit upgrading the first security client to be a second security client based on the upgrade data, and
wherein when the first security client is upgraded to be the second security client, the list management unit upgrades information regarding the first security client, which is included in the security client list, with information regarding the second security client.

15. The apparatus of claim 10, wherein the at least one security module comprises a universal serial bus (USB) or a smart card, and
further comprising a communication interface communicating with the at lest one security module.

16. The apparatus of claim 10, wherein the at least one security module is installed in the form of a chip set in the apparatus.

17. The apparatus of claim 9, wherein the security clients are software-based modules that constitute a conditional access system (CAS).

18. (canceled)
